(19) United States
(12) Patent Application Publication
(10) Pub. No.: US 2014/0126198 A1
(43) Pub. Date: May 8, 2014

(54) ILLUMINATION SYSTEM WITH LIGHT EMITTING DIODES ARRANGED ON NONPLANAR FLAT SURFACES

(71) Applicant: Timothy Dominic Dorney, Plano, TX (US)

(72) Inventor: Timothy Dominic Dorney, Plano, TX (US)

(21) Appl. No.: 14/063,168

(22) Filed: Oct. 25, 2013

Related U.S. Application Data
(60) Provisional application No. 61/724,092, filed on Nov. 8, 2012.

(51) Int. Cl. F21K 99/00

(52) U.S. Cl. CPC F21K 9/17; F21K 9/90
USPC 362/218; 29/428

(57) ABSTRACT

A method and apparatus for an illumination system includes a linear metal heat sink with at least a first planar surface and a second planar surface. The first planar surface is positioned substantially nonplanar with the second planar surface, and at least a portion of the linear metal heat sink is designed for exposure to free air. A first plurality of light emitting diodes is attached on the first planar surface, and a second plurality of light emitting diodes is attached on the second planar surface.

This application claims priority over provisional application No. 61/724,092 filed Nov. 8, 2012.

### BACKGROUND OF INVENTION

Linear fluorescent bulbs have provided illumination for decades. The central element in a fluorescent bulb is a sealed glass tube. The tube contains a small amount of mercury and an inert gas, typically argon, kept under very low pressure. The tube also contains a phosphor powder, coated along the inside of the glass. The tube has two electrodes, one at each end, which are wired to an electrical circuit, known as a ballast.

When the fluorescent bulb is turned on, current flows through the electrical circuit to the electrodes. There is a considerable voltage across the electrodes, so electrons will migrate through the gas from one end of the tube to the other. This energy changes some of the mercury in the tube from a liquid to a gas. As electrons and charged atoms move through the tube, some of them will collide with the gaseous mercury atoms. These collisions excite the atoms, bumping electrons up to higher energy levels. When the electrons return to their original energy level, they release ultraviolet wavelength photons.

When a photon hits the fluorescent bulb's phosphor powder coating, one of the phosphor's electrons jumps to a higher energy level and the atom heats up. When the electron falls back to its normal level, it releases energy in the form of another photon. This photon has less energy than the original photon, because some energy was lost as heat. In a fluorescent bulb, the emitted light is in the visible spectrum. In other words, the phosphor gives off white light. Manufacturers can vary the color of the light by using different combinations of phosphors.

The wavelengths of the white light produced by a fluorescent bulb do not match very well with the typical human visual system. Accordingly, the quality of white light produced by a fluorescent bulb Color Rendering Index (CRI) is often in the 60-80 range, on a 100 point scale.

Other shortcomings in fluorescent bulbs result from their construction. The entire inner surface of the fluorescent bulb is coated by phosphor powder. When the fluorescent bulb is turned on, light is produced in all directions. Some of the light is sent directly to the area to be illuminated. Other portions of the light may be reflected toward the area to be illuminated. Typically, reflecting light results in significant light losses.

Furthermore, an illumination system with fluorescent bulbs typically generates about 80 lumens/Watt, generates waste heat as part of the phosphorous conversion of ultraviolet photon into visible light, and reduces the lifetime of the fluorescent bulb each time it is turned on.

Lately, fluorescent bulbs have started to be replaced by linear light emitting diode bulbs. As shown in FIG. 1, a linear light emitting diode bulb 100 has the same general shape as a fluorescent bulb. The linear light emitting diode bulb 100 includes a linear tube 101 and end caps 102. The end caps 102 overlap the linear tube 101 and contain one or more conductive pins to both hold the linear light emitting diode bulb 100 into a fixture and conduct electricity to the linear tube 101.

As mentioned previously, fluorescent bulbs require a ballast to operate. Typically, a linear light emitting diode bulb 100 has a different electrical requirement than fluorescent bulbs. A linear light emitting diode bulb 100 may have a power supply enclosed within the linear tube 101. In this case, the linear light emitting diode bulb 100 may operate directly from the main power lines. Likewise, an external power supply may be used to power the linear light emitting diode bulb 100.

FIG. 2 shows a cross section of a typical linear light emitting diode bulb 200 along section line A-A shown in FIG. 1. A linear tube 101 includes a linear metal heat sink 240 with a shape arranged to mate with a plastic cover 210. The plastic cover 210 may be clear. The plastic cover 210 may be cloudy or shaped to provide diffusion. Concave sections may also be formed in the linear metal heat sink 240 to support attachment of end caps 102 with screws, or likewise, for attaching the linear metal heat sink 240 to a larger illumination system.

The linear metal heat sink 240 includes a flat mounting surface on which to attach printed circuit board 230. Light emitting diodes 220 are attached to the printed circuit board 230. Accordingly, the light emitting diodes 220 are attached on the flat mounting surface.

Light emitting diodes 220 have a lifetime dictated by the duration and amount of heat to which they are subjected. As the amount of time increases for which the light emitting diodes 220 are on, the light produced decreases. The rate at which the light decreases is governed by the temperature at which the light emitting diodes 220 operate (under normal operating conditions). The linear metal heat sink 240 helps reduce the temperature on the light emitting diodes 220 by exposing a portion of the light emitting diodes 220 to a lower temperature mounting surface.

The bottom of FIG. 2 contains a portion of the linear metal heat sink 240 exposed to free air. The middle of FIG. 2 contains an upper portion of the linear metal heat sink 240 that contacts the printed circuit board 230, and indirectly, the light emitting diodes 220. Conduction heat transfer allows the heat generated by the light emitting diodes 220 to travel to the portion of the linear metal heat sink 240 exposed to free air.

A linear light emitting diode bulb 100 has a lifetime that greatly exceeds a fluorescent bulb. Furthermore, a linear light emitting diode bulb 100 does not reduce its lifetime each time it is turned on. Also, a linear light emitting diode bulb 100 does not generate as much heat as a fluorescent bulb, is typically more energy efficient, and produces a better quality visible light with a Color Rendering Index (CRI) often in the 70-85 range.

Based on the orientation of FIG. 2, the light emitting diodes 220 project light in an upward direction when they are turned on. In operation, the linear light emitting diode bulb 200 would typically be oriented with its plastic cover 210 in a downward direction to produce illumination above a desired area. Typical light emitting diodes 220 (without additional optics) have a full width, half maximum angle of illumination about 110 to 120 degrees. Therefore, unlike typical fluorescent bulbs, the light from a typical linear light emitting diode bulb 200 is very directional.

### SUMMARY OF INVENTION

According to one aspect of one or more embodiments of the present invention, the present invention relates to an illumination system including a linear metal heat sink with at least a first planar surface and a second planar surface. The first planar surface is positioned substantially nonplanar with the second planar surface, and at least a portion of the linear metal heat sink is designed for exposure to free air. A first plurality of light emitting diodes is attached on the first planar surface, and a second plurality of light emitting diodes is attached on the second planar surface.

According to one aspect of one or more embodiments of the present invention, the present invention relates to an illumination system including a linear metal heat sink with at least a portion of the linear metal heat sink designed for exposure to free air. A cross section of the linear metal heat sink includes a shape designed to provide a Venturi effect. Also, a plurality of light emitting diodes is attached on the linear metal heat sink.

According to one aspect of one or more embodiments of the present invention, the present invention relates to a method of manufacture of an illumination system including forming a linear metal heat sink with at least a first planar surface and a second planar surface. The first planar surface is positioned substantially nonplanar with the second planar surface, and another surface of the linear metal heat sink is for heat transfer in free air. The method of manufacture further includes attaching a first plurality of light emitting diodes on the first planar surface, and attaching a second plurality of light emitting diodes on the second planar surface.

Other aspects and advantages of the invention will be apparent from the following description and the appended claims.

### BRIEF DESCRIPTION OF DRAWINGS

FIG. 1 shows a diagram of a linear light emitting diode bulb.

FIG. 2 shows a cross section of a typical linear light emitting diode bulb.

FIG. 3 shows a cross section of a linear light emitting diode illumination system in accordance with an embodiment of the present invention.

FIG. 4 shows a cross section of a linear light emitting diode illumination system in accordance with an embodiment of the present invention.

FIG. 5 shows a cross section of a linear light emitting diode illumination system with fins in accordance with an embodiment of the present invention.

FIG. 6 shows a cross section of a linear light emitting diode illumination system with a shape that provides a Venturi effect in accordance with an embodiment of the present invention.

FIG. 7 shows a cross section of an illumination system with a troffer with light emitting diodes attached to a bottom side linear metal heat sink in accordance with an embodiment of the present invention.

FIG. 8 shows a cross section of an illumination system with a troffer with light emitting diodes attached to a top side linear metal heat sink in accordance with an embodiment of the present invention.

### DETAILED DESCRIPTION

One of ordinary skill in the art will understand for the purposes of the present invention that “nonplanar” means two surfaces are substantially not in the same plane, and are not in two different planes that are substantially parallel to each other. The result of attaching light emitting diodes on planar surfaces is that unaltered light from the light emitting diodes may substantially point in the same direction or may substantially point in completely opposite directions (180 degrees from each other) depending on the direction in which the light emitting diodes are attached.

One of ordinary skill in the art will understand for the purposes of the present invention that attaching “on” a surface encompasses both direct and indirect attachment. An object is attached on a surface if the object directly touches a surface on which it is attached. Furthermore, an object is attached on a surface if the object is attached and directly touches a substrate, where the substrate is attached on a surface. Also, interposers may exist between the object and the substrate and/or between the substrate and the surface, and still be considered as an object attached on a surface. Attaching “on” a surface is intended to provide a substantial heat conduction path between a heat generating object, such as a light emitting diode, and a heat dissipating object, such as a planar (i.e., flat) surface of a heat sink.

One of ordinary skill in the art will understand for the purposes of the present invention that an illumination system includes, but is not limited to, a linear light emitting diode bulb. The linear light emitting diode bulb may or may not have incorporated a power supply within the linear light emitting diode bulb. Furthermore, an illumination system includes, but is not limited to, a linear light emitting diode bulb and a fixture that holds the linear light emitting diode bulb, and a power supply. The fixture may reflect and/or diffuse the light from a linear light emitting diode bulb. Also, an illumination system includes, but is not limited to, light emitting diodes attached on a heat sink such that the heat sink is incorporated into the illumination system and not intended to be typically removable. An illumination system may be used in a high or low bay environment, as a fixture in a tiled ceiling, or as a replaceable component used in place of a fluorescent bulb after by-passing the fluorescent bulb power supply.

For clarity, like numbered elements may exist across several figures to represent elements with similar function, design, and/or operation.

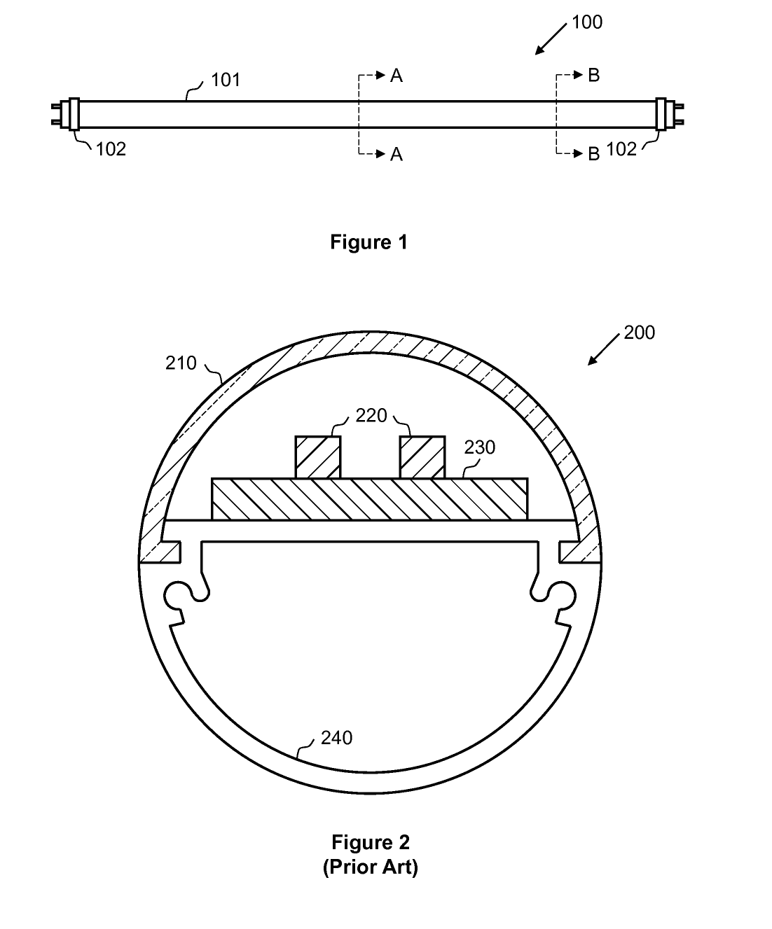

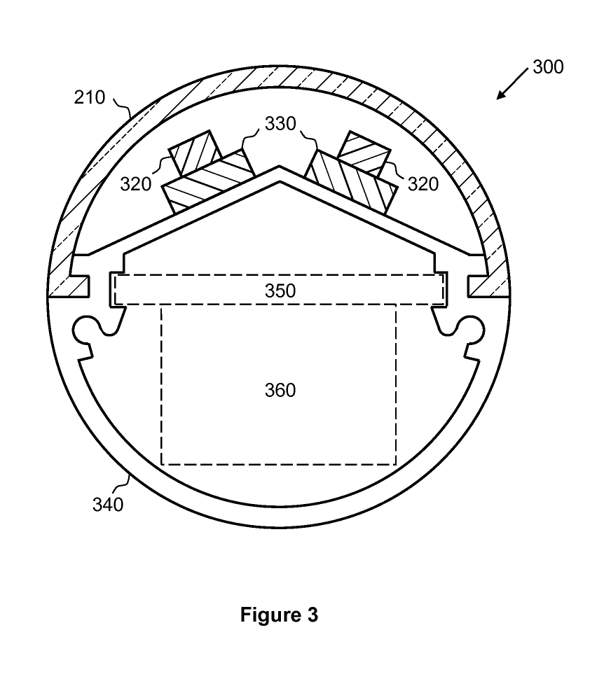

FIG. 3 shows a cross section of a linear light emitting diode bulb 300 along section line B-B shown in FIG. 1 in accordance with an embodiment of the present invention. A linear tube 101 includes a linear metal heat sink 340 with a shape arranged to mate with a plastic cover 210. The plastic cover 210 may be clear. The plastic cover 210 may be cloudy or shaped to provide diffusion. Concave sections may also be formed in the linear metal heat sink 340 to support attachment of end caps 102 with screws, or likewise, for attaching the linear metal heat sink 340 to a larger illumination system.

The linear metal heat sink 340 includes two flat (i.e., planar) mounting surfaces on which to attach printed circuit boards 330. Light emitting diodes 320 are attached to the printed circuit board 330. Accordingly, the light emitting diodes 320 are attached on the flat mounting surfaces. The flat surfaces are not in the same plane, which results in the light from the light emitting diodes 320 to have a substantially broader illumination area.

By angling the two flat (i.e., planar) mounting surfaces of the linear metal heat sink 340, a wider projection angle is provided. By angling each flat mounting surface 25 degrees from horizontal, the full width, half maximum angle of illumination of the combined light emitting diodes 320 is increased from approximately 120 degrees to approximately 170 degrees.

One of ordinary skill in the art, having benefit of the present invention, will understand that printed circuit boards intended to help reduce the heat in the light emitting diodes during operation may take a variety of forms. Metal-core printed circuit boards (MCPCB), metal-core printed circuit boards with direct connection between a light emitting diode thermal slug and the metal-core, conventional printed circuit boards with thermally conductive vias, and conventional printed circuit boards may be used.

A plurality of light emitting diodes 320 are attached to the printed circuit board 330 if the printed circuit board 330 is viewed going into and/or out of the page. The plurality of light emitting diodes 320 may all have a color temperature or a primary wavelength that are substantially the same. Alternatively, the plurality of light emitting diodes 320 may have different color temperatures. Higher color temperature white light emitting diodes often have a greater flux than lower color temperature white light emitting diodes. Likewise, the plurality of light emitting diodes 320 may have different primary wavelengths Improved color rendering index (CRI) may occur by mixing white light emitting diodes with light emitting diodes of one or more specific colors to better match a typical human visual system. One of ordinary skill in the art will understand for the purposes of the present invention that white light emitting diodes may be assigned a primary wavelength by selecting the maximum, average, mean, etc., wavelength that represents the constituent wavelengths from the human visible spectrum.

Like the prior art in FIG. 2, the linear metal heat sink 340 helps reduce the temperature on the light emitting diodes 320 by exposing a portion of the light emitting diodes 320 to a lower temperature mounting surface. The outer surface of linear metal heat sink 340 is exposed to free air. Conduction allows the heat generated by the light emitting diodes 320 to travel to the portion of the linear metal heat sink 340 exposed to free air. The metal heat sink 340 may be formed by extrusion.

The linear metal heat sink 340 has a cross section of at least a portion of a circular shape. The linear metal heat sink 340 may also have a channel to support an internal power supply. As shown in FIG. 3, two channels support a power supply printed circuit board 350. In turn, the power supply printed circuit board 350 supports a variety of circuit elements 360. The internal power supply may convert AC mains power, AC power, and/or DC power to a power supply compatible for powering the light emitting diodes 320.

The internal power supply comprising the power supply printed circuit board 350 and circuit elements 360 may not run the entire length of the linear metal heat sink 340. Furthermore, the internal power supply may be connected to only one end cap 102, or both. If the internal power supply is connected to both end caps 102, the two pins on each end cap may be shorted together. Also, if the internal power supply is connected to only one end cap 102, each pin of the connected end cap 102 may connect to a different voltage potential. The unconnected end cap 102 may have its pins shorted.

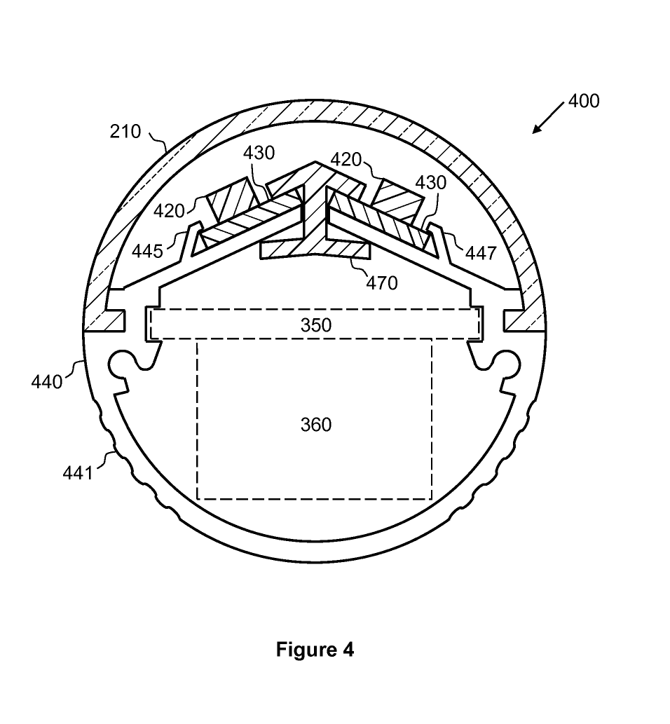

FIG. 4 shows a cross section of a linear light emitting diode bulb 400 along section line B-B shown in FIG. 1 in accordance with an embodiment of the present invention. A linear tube 101 includes a linear metal heat sink 440 with a shape arranged to mate with a plastic cover 210. The plastic cover 210 may be clear. The plastic cover 210 may be cloudy or shaped to provide diffusion. Concave sections may also be formed in the linear metal heat sink 440 to support attachment of end caps 102 with screws, or likewise, for attaching the linear metal heat sink 440 to a larger illumination system.

The linear metal heat sink 440 includes two flat (i.e., planar) mounting surfaces on which to attach printed circuit board 430. Light emitting diodes 420 are attached to the printed circuit board 430. Accordingly, the light emitting diodes 420 are attached on the flat mounting surfaces. The flat surfaces are not in the same plane, which results in the light from the light emitting diodes 420 to have a substantially broader illumination area.

By angling the two flat (i.e., planar) mounting surfaces of the linear metal heat sink 440, a wider projection angle is provided. By angling each flat mounting surface 25 degrees from horizontal, the full width, half maximum angle of illumination of the combined light emitting diodes 420 is increased from approximately 120 degrees to approximately 170 degrees.

One of ordinary skill in the art, having benefit of the present invention, will understand that printed circuit boards intended to help reduce the heat in the light emitting diodes during operation may take a variety of forms. Metal-core printed circuit boards (MCPCB), metal-core printed circuit boards with direct connection between a light emitting diode thermal slug and the metal-core, conventional printed circuit boards with thermally conductive vias, and conventional printed circuit boards may be used. In FIG. 4, the printed circuit board 430 is reduced in thickness to lower the thermal resistivity of the printed circuit board 430.

A plurality of light emitting diodes 420 are attached to the printed circuit board 430 if the printed circuit board 430 is viewed going into and/or out of the page. The plurality of light emitting diodes 420 may all have a color temperature or a primary wavelength that are substantially the same. Alternatively, the plurality of light emitting diodes 420 may have different color temperatures. Higher color temperature white light emitting diodes often have a greater flux than lower color temperature white light emitting diodes. Likewise, the plurality of light emitting diodes 420 may have different primary wavelengths Improved color rendering index (CRI) may occur by mixing white light emitting diodes with light emitting diodes of one or more specific colors to better match a typical human visual system. One of ordinary skill in the art will understand for the purposes of the present invention that white light emitting diodes may be assigned a primary wavelength by selecting the maximum, average, mean, etc., wavelength that represents the constituent wavelengths from the human visible spectrum.

Like the prior art in FIG. 2, the linear metal heat sink 440 helps reduce the temperature on the light emitting diodes 420 by exposing a portion of the light emitting diodes 420 to a lower temperature mounting surface. The outer surface of linear metal heat sink 440 is exposed to free air. Conduction allows the heat generated by the light emitting diodes 420 to travel to the portion of the linear metal heat sink 440 exposed to free air.

The linear metal heat sink 440 has a cross section of at least a portion of a circular shape. The linear metal heat sink 440 may also have a channel to support an internal power supply as already discussed with regards to FIG. 3.

The linear metal heat sink 440 includes a first linear channel 447 parallel with a long direction of the linear metal heat sink 440 on the right flat mounting surface. The first linear channel 447 provides at least a portion of the attachment of the right printed circuit board 430 onto the flat mounting surface of the linear metal heat sink 440. Furthermore, the linear metal heat sink 440 includes a second linear channel 445 parallel with a long direction of the linear metal heat sink 440 on the left flat mounting surface. The second linear channel 445 provides at least a portion of the attachment of the left printed circuit board 430 onto the flat mounting surface of the linear metal heat sink 440.

In this embodiment, both the first linear channel 447 and/or the second linear channel 445 comprise straight edges, angled inward toward the flat mounting surfaces of the linear metal heat sink 440 to provide a portion of the attachment of the right and left, respectively, printed circuit board 430 to the flat mounting surfaces of the linear metal heat sink 440. Furthermore, inward angling the first linear channel 447 and/or the second linear channel 445 may compress the printed circuit board 430 onto the flat mounting surfaces of the linear metal heat sink 440 to improve thermal conductivity.

The printed circuit board 430 may be in direct contact with the flat mounting surfaces of the linear metal heat sink 440. Alternatively, conductive thermal grease, thermally conductive film, or the like, may be used between the printed circuit board 430 and the flat mounting surfaces of the linear metal heat sink 440. One of ordinary skill in the art, having benefit of the present invention, will understand using a conductive material between a printed circuit board 430 attached to a flat mounting surface of the linear metal heat sink 440 still provides for the printed circuit board 430 being on the flat mounting surface of the linear metal heat sink 440.

Also, the first linear channel 447 and/or the second linear channel 445 may be designed in an upside-down L shape to provide at least a portion of the attachment of the printed circuit board 430 to the flat mounting surfaces of the linear metal heat sink 440. One of ordinary skill in the art, having benefit of the present invention, will understand that the linear channels 445, 447 may take a variety of shapes to retain the printed circuit board 430.

To create a force to compress the printed circuit board 430 into the linear channel 445 and linear channel 447 and provide at least a portion of the attachment of the printed circuit board 430 to the flat mounting surfaces of the linear metal heat sink 440, a retaining clip 470 is used. The retaining clip 470 may create a downward force on the printed circuit board 430 because the retaining clip 470 creates a spring interference. Likewise, the plastic cover 210 may create an inward force that compresses the two flat mounting surfaces toward the center. In doing so, the retaining clip 470 provides a stop against any further compression and likewise creates an inward force on the printed circuit boards 430 to press them into the linear channel 445 and linear channel 447.

Manufacture of the printed circuit board 430 may result in small variations in the width to the printed circuit board 430. Because the retaining clip 470 has a spring interference fit, and the plastic cover 210 may create an inward force, both of these elements may adjust to the small manufacturing variations.

The retaining clip 470 may be manufactured from plastic. Other non-conductive materials may be used if electrical isolation is of concern. If electrical isolation is not of concern, the retaining clip 470 may be manufactured from metal. Furthermore, the retaining clip 470 may be integral to the linear metal heat sink 440 and manufactured as part of the manufacture of the metal heat sink 440. In this case the retaining clip 470 would be metal. The retaining clip 470 may also be created to support only one of the two printed circuit boards 430. In this case, a separate retaining clip 470 may be designed for each printed circuit board 430.

Because the printed circuit board 430 is thin and may bend, it is intended that the retaining clip 470 generally run the length of the linear tube 101 to maintain a consistent pressure on the printed circuit board 430 onto the flat mounting surfaces of the linear metal heat sink 440. In this manner, the printed circuit board 430 maintains their contact surface with the metal heat sink 440. However, it may be advantageous to cut or manufacture the retaining clip 470 in sections. By creating breaks in the length of the retaining clip 470, connecting wires may be able to pass to the top surface as needed. Also, air may be able to circulate around the internal power supply and the light emitting diodes 420 to the linear metal heat sink 440 and plastic cover 210 for better thermal performance. Also, the retaining clip 470 may be manufactured in short segments to be spaced along the length of the linear tube 101.

As described above, the linear channel 445 and linear channel 447 and retaining clip 470 create an attachment system to hold the printed circuit board 430 onto the linear metal heat sink 440 to improve thermal performance of the linear light emitting diode bulb 100.

Other features of the linear light emitting diode bulb 100 may also improve thermal performance. In FIG. 4, the linear metal heat sink 440 comprises a structure 441 to increase an external perimeter designed for exposure to free air. The metal heat sink 440 may be formed by extrusion.

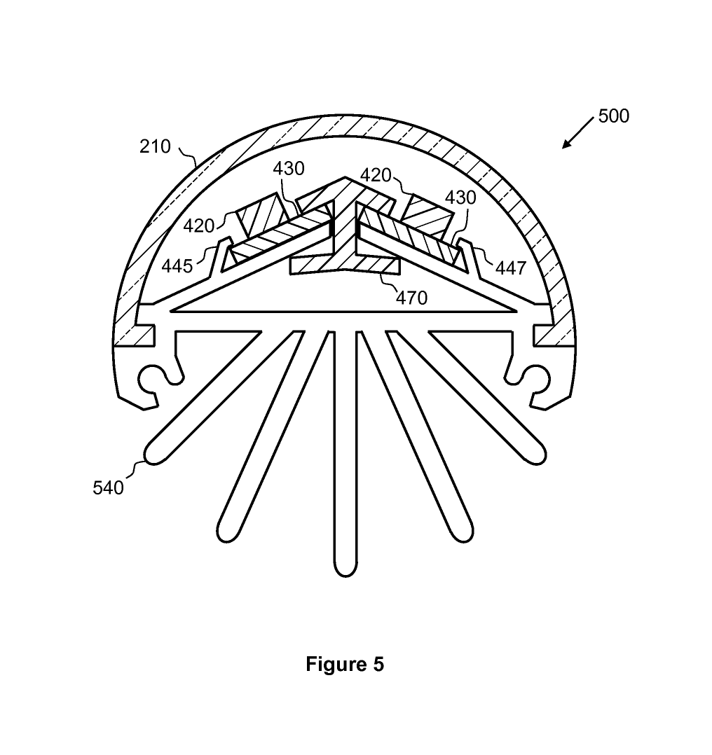

FIG. 5 shows a cross section of a linear light emitting diode bulb 500 along section line B-B shown in FIG. 1 in accordance with an embodiment of the present invention. A linear tube 101 includes a linear metal heat sink 540 with a shape arranged to mate with a plastic cover 210. The plastic cover 210 may be clear. The plastic cover 210 may be cloudy or shaped to provide diffusion. Concave sections may also be formed in the linear metal heat sink 540 to support attachment of end caps 102 with screws, or likewise, for attaching the linear metal heat sink 440 to a larger illumination system.

The linear metal heat sink 540 includes many of the features already discussed with regards to FIG. 4. These common features share the same element numbers.

The linear metal heat sink 540 is designed not to incorporate a power supply within the linear metal heat sink 540 as shown with regards to FIG. 3 or 4. A power supply may be external to linear light emitting diode bulb 500. Alternatively, a power supply may be approximately at the positional location of the printed circuit board 430 within the linear light emitting diode bulb 500. Accordingly, the linear metal heat sink 540 allows the cross sectional area used to house a power supply in FIGS. 3 and 4 to instead be used to increase an external perimeter designed for exposure to free air. In FIG. 5, fins are formed. The fins help with the removal of heat created by the light emitting diodes 420 by convection heat transfer into free air.

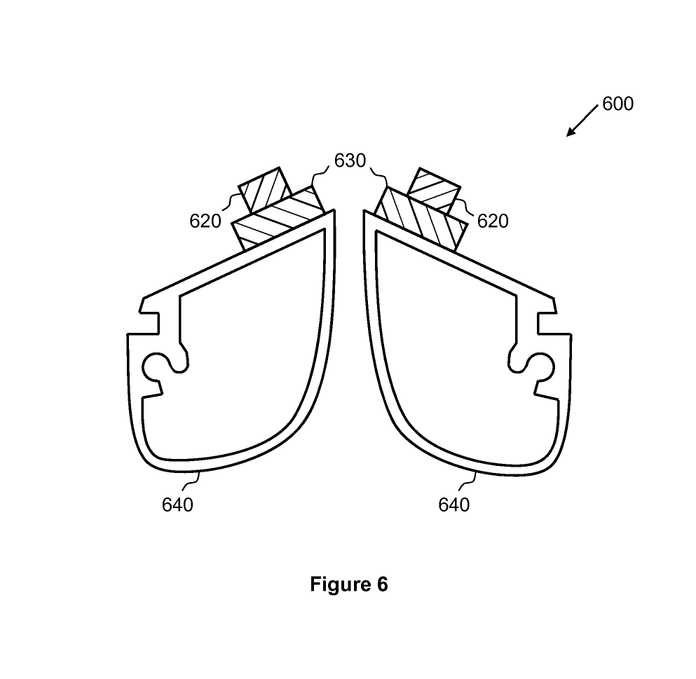

FIG. 6 shows a portion of an illumination system 600 in accordance with an embodiment of the present invention. A cross section of linear metal heat sink 640 has a shape arranged to mate with other components. A plastic cover (not shown) may mate with linear metal heat sink 640. The plastic cover may be clear, cloudy, or shaped to provide diffusion. Also, concave sections may be formed in the linear metal heat sink 640 to support attachment to other components of the illumination system 600 with screws, or likewise.

The linear metal heat sink 640 is designed not to incorporate a power supply within the linear metal heat sink 640 as shown with regards to FIG. 3 or 4. A power supply may be external to linear metal heat sink 640. Alternatively, a power supply may be approximately at the positional location of the printed circuit board 630 on linear metal heat sink 640. Accordingly, the linear metal heat sink 640 allows the cross sectional area used to house a power supply in FIGS. 3 and 4 to instead be used to increase the removal of heat created by the light emitting diodes 620 by convection heat transfer into free air.

The linear metal heat sink 640 has a cross section shaped to provide a Venturi effect. Accordingly, a rate of airflow through the Venturi section may increase. To allow the airflow, a plastic cover is designed to limit impeding the airflow.

The linear metal heat sink 640 may be designed to incorporate some of the features discussed in other embodiments such as linear channels, retaining clips, and fins. The surfaces of the linear metal heat sink 640 used to support the printed circuit board 630 may or may not be planar.

One of ordinary skill in the art, having benefit of the present invention, will understand that printed circuit boards intended to help reduce the heat in the light emitting diodes during operation may take a variety of forms. Metal-core printed circuit boards (MCPCB), metal-core printed circuit boards with direct connection between a light emitting diode thermal slug and the metal-core, conventional printed circuit boards with thermally conductive vias, and conventional printed circuit boards may be used.

A plurality of light emitting diodes 620 are attached to the printed circuit board 630 if the printed circuit board 630 is viewed going into and/or out of the page. The plurality of light emitting diodes 620 may all have a color temperature or a primary wavelength that are substantially the same. Alternatively, the plurality of light emitting diodes 620 may have different color temperatures. Higher color temperature white light emitting diodes often have a greater flux than lower color temperature white light emitting diodes. Likewise, the plurality of light emitting diodes 620 may have different primary wavelengths Improved color rendering index (CRI) may occur by mixing white light emitting diodes with light emitting diodes of one or more specific colors to better match a typical human visual system. One of ordinary skill in the art will understand for the purposes of the present invention that white light emitting diodes may be assigned a primary wavelength by selecting the maximum, average, mean, etc., wavelength that represents the constituent wavelengths from the human visible spectrum.

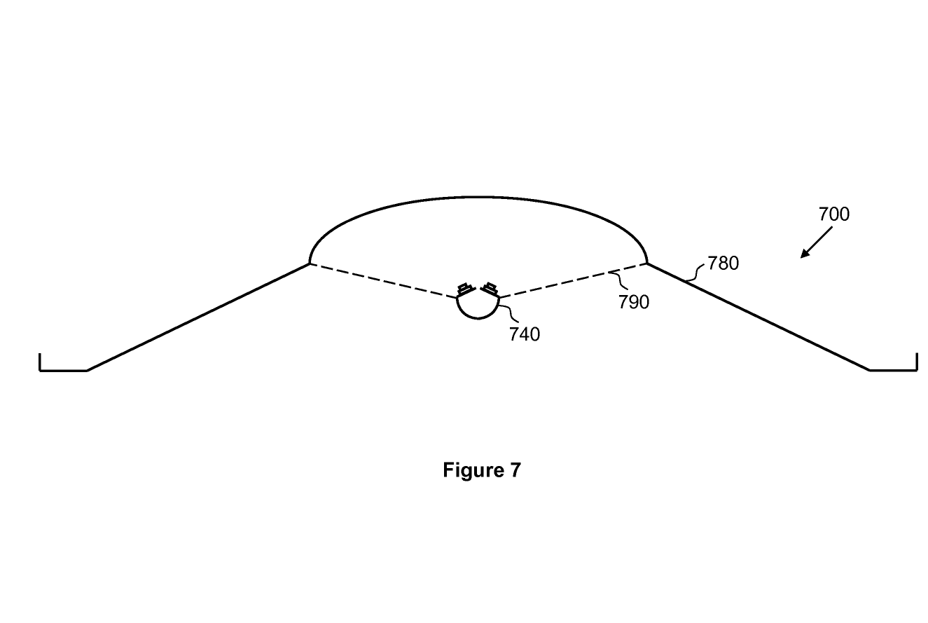

FIG. 7 shows a cross section of an illumination system 700 with a troffer 780 in accordance with an embodiment of the present invention. The illumination system 700 may be arranged to be suspended from a ceiling. Alternatively, illumination system 700 may be arranged to be integrated into a ceiling system, such as a tiled ceiling system common to offices and retail spaces.

The troffer 780 may be used to support other components and to maintain the shape of the illumination system 700. A heat sink 740 supports light emitting diodes and helps transfer heat away from the light emitting diodes. The heat sink 740 may be designed according to any of the teachings shown in FIGS. 3-6. In the case of a Venturi effect arrangement, a plastic cover 790 and/or the troffer 780 are designed to limit impeding the airflow.

The heat sink 740 is also designed to support the plastic cover 790 positioned between the heat sink 740 and the troffer 780. The troffer 780 is also designed to support the plastic cover 790. Light is produced by the light emitting diodes contained on heat sink 740, reflected, then transmitted through the plastic cover 790.

The plastic cover 790 is included to prevent a person from contacting the light emitting diodes contained on heat sink 740, and/or to diffuse and/or color mix the light provided by the light emitting diodes on heat sink 740. The plastic cover 790 may be clear, cloudy, or shaped to provide diffusion. The plastic cover 790 may be one piece or formed from multiple pieces. Furthermore, a portion of the troffer 780 near the heat sink 740 may be shaped to diffuse and/or color mix the light provided by the light emitting diodes on heat sink 740. Also, the troffer 780 may be shaped or manufactured to support another element (not shown) to diffuse and/or color mix the light provided by the light emitting diodes on heat sink 740. The troffer 780 may also provide a means to support a power supply for the light emitting diodes.

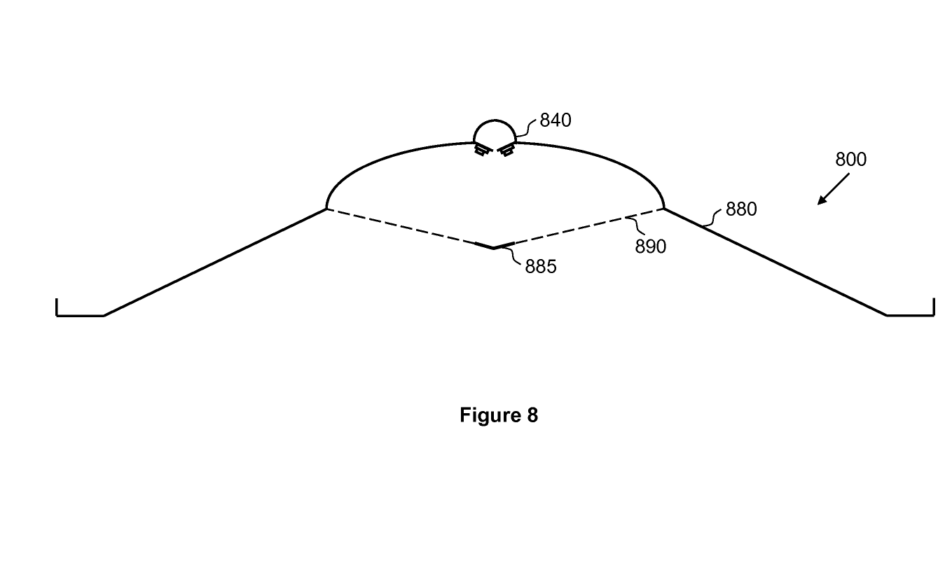

FIG. 8 shows a cross section of an illumination system 800 with a troffer 880 in accordance with an embodiment of the present invention. The illumination system 800 may be arranged to be suspended from a ceiling. Alternatively, illumination system 800 may be arranged to be integrated into a ceiling system, such as a tiled ceiling system common to offices and retail spaces.

The troffer 880 may be used to support other components and to maintain the shape of the illumination system 800. A heat sink 840 supports light emitting diodes and helps transfer heat away from the light emitting diodes. The heat sink 840 may be designed according to any of the teachings shown in FIGS. 3-6. In the case of a Venturi effect arrangement, a plastic cover 890 and/or the troffer 880 are designed to limit impeding the airflow.

A structural element 885 is designed to support the plastic cover 890 positioned between the structural element 885 and the troffer 880. The troffer 880 is also designed to support the plastic cover 890. Light is produced by the light emitting diodes contained on heat sink 840 and transmitted through the plastic cover 890.

The plastic cover 890 is included to prevent a person from contacting the light emitting diodes contained on heat sink 840, and/or to diffuse and/or color mix the light provided by the light emitting diodes on heat sink 840. The plastic cover 890 may be clear, cloudy, or shaped to provide diffusion. The plastic cover 890 may be one piece or formed from multiple pieces. If the plastic cover 890 is a single piece, the structural element 885 may not be incorporated in the illumination system 800.

A portion of the troffer 880 near the heat sink 840 may be shaped to diffuse and/or color mix the light provided by the light emitting diodes on heat sink 840. Also, the troffer 880 may be shaped or manufactured to support another element (not shown) to diffuse and/or color mix the light provided by the light emitting diodes on heat sink 840. The troffer 880 may also provide a means to support a power supply for the light emitting diodes.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An illumination system, comprising:
a linear metal heat sink with at least a first planar surface and a second planar surface, the first planar surface positioned substantially nonplanar with the second planar surface, at least a portion of the linear metal heat sink designed for exposure to free air;
a first plurality of light emitting diodes attached on the first planar surface; and
a second plurality of light emitting diodes attached on the second planar surface.

2. The illumination system of claim 1, further comprising a first linear channel parallel with a long direction of the linear metal heat sink integral with the first planar surface, the first plurality of light emitting diodes mounted on a first printed circuit board, the first linear channel arranged to provide at least a portion of the attachment of the first printed circuit board on the first planar surface.

3. The illumination system of claim 2, the first printed circuit board in direct contact with the first planar surface.

4. The illumination system of claim 2, further comprising a second linear channel parallel with the long direction of the linear metal heat sink integral with the second planar surface, the second plurality of light emitting diodes mounted on a second printed circuit board, the second linear channel arranged to provide at least a portion of the attachment of the second printed circuit board on the second planar surface.

5. The illumination system of claim 2, further comprising a retaining clip to provide at least a portion of the attachment of the first printed circuit board on the first planar surface.

6. The illumination system of claim 4, further comprising a retaining clip to provide at least a portion of the attachment of the first printed circuit board on the first planar surface and the second printed circuit board on the second planar surface.

7. The illumination system of claim 6, the retaining clip is comprised of plastic.

8. The illumination system of claim 4, the second printed circuit board in direct contact with the second planar surface.

9. The illumination system of claim 1, a cross section of the linear metal heat sink comprises fins.

10. The illumination system of claim 1, a cross section of the linear metal heat sink comprises at least a portion of a circular shape; and
further comprising a power supply.

11. The illumination system of claim 10, the at least the portion of the circular shape comprises a structure to increase an external perimeter designed for exposure to free air.

12. The illumination system of claim 1, further comprising a power supply.

13. The illumination system of claim 1, a cross section of the linear metal heat sink comprises at least a portion of a circular shape designed to fit in place of a fluorescent linear tube bulb.

14. The illumination system of claim 1, the linear metal heat sink formed by extrusion.

15. The illumination system of claim 1, further comprising a troffer and a power supply.

16. The illumination system of claim 1, the first plurality of light emitting diodes comprise light emitting diodes of different primary wavelengths;
and the second plurality of light emitting diodes comprise light emitting diodes of different primary wavelengths.

17. An illumination system, comprising:
a linear metal heat sink, at least a portion of the linear metal heat sink designed for exposure to free air, a cross section of the linear metal heat sink comprises a shape designed to provide a Venturi effect; and
a plurality of light emitting diodes attached on the linear metal heat sink.

18. A method of manufacture of an illumination system, comprising:
forming a linear metal heat sink with at least a first planar surface and a second planar surface, the first planar surface positioned substantially nonplanar with the second planar surface, another surface of the linear metal heat sink for heat transfer in free air;
attaching a first plurality of light emitting diodes on the first planar surface; and
attaching a second plurality of light emitting diodes on the second planar surface.

19. The method of manufacture of claim 18, the forming comprises extrusion.

20. The method of manufacture of claim 19, the forming further comprising:
forming a first linear channel parallel with a direction of extrusion of the linear metal heat sink on the first planar surface, the first linear channel arranged to at least in part provide attachment of the first plurality of light emitting diodes; and
forming a second linear channel parallel with the direction of extrusion of the linear metal heat sink on the second planar surface, the second linear channel arranged to at least in part provide attachment of the second plurality of light emitting diodes.
